(19) United States
(12) Patent Application Publication
(10) Pub. No.: US 2017/0178167 A1
(43) Pub. Date: Jun. 22, 2017

(54) METHOD FOR PREDICTING A DEMAND FOR A BUSINESS

(71) Applicant: MASTERCARD INTERNATIONAL INCORPORATED, Purchase, NY (US)

(72) Inventors: Avyaktanand Tiwary, Gurgaon (IN); Sharan Bakshiram, Gurgaon (IN); Suneel Bhatt, Delhi (IN)

(21) Appl. No.: 15/386,112

(22) Filed: Dec. 21, 2016

(30) Foreign Application Priority Data
Dec. 21, 2015 (SG) 10201510521U

(51) Int. Cl. G06Q 30/02

(52) U.S. Cl. CPC G06Q 30/0205; G06Q 30/0201

(57) ABSTRACT

A method for predicting a demand for a business, the method comprising the steps of: generating purchase preference in at least one target location based on payment transaction information and merchant information retrieved from one or more databases, wherein the payment transaction information relates to a plurality of historical payment transactions made between a plurality of existing merchants and a plurality of consumers and wherein the merchant information comprises a merchant location of each of the plurality of existing merchants; and predicting the demand in the at least one target location, based on the purchase preference.

### FIELD OF INVENTION

The present invention relates broadly, but not exclusively, to methods for predicting a demand for a business.

### BACKGROUND

While many business owners establish their businesses online, there are still many that rely heavily on a brick-and-mortar or a physical store. Some examples of the latter include restaurants, hotels and drug stores. There are various factors that determine the success of a business with physical presence. One of the factors is the location of the physical store. There is no doubt that the location of the physical store is critical to business success. In other words, site selection is of vital importance for this type of business.

There are many ways that a business owner may conduct a location analysis in a particular area. For example, one may survey the surrounding area by walking or driving around the site of a potential store to estimate the viability of setting up the business at the store. With the advent of internet, the task may be simplified by relying on information online, such as online maps and websites. This may provide an estimate to the traffic pattern surrounding the area of a potential store.

However, surveying the surrounding area of the potential store may provide little information to the market or demand of the business in that area. In other words, a prime retail location with excellent traffic pattern may not guarantee that the business will succeed. This may be due to a low concentration of the target customers in close proximity, competition from nearby stores and etc. A market research is typically conducted to determine the market or demand, i.e. to determine how willing or frequent the customers willing to travel to purchase the products or services. A demand analysis is as important as the traffic pattern of the store when doing a site selection.

While many would hazard a prediction of the demand based on their gut feeling, there are various tools to assist business owners in the analysis. Examples of tools include marketing/customer survey, which includes sampling and analyzing information gathered from potential consumers. Conventionally, the information can be gathered by questionnaires or by interviewing a selected group of consumers. However, the surveying methods described above can be sluggish, time-consuming, costly and yet, inaccurate and incomprehensive.

A need therefore exists to provide a method for predicting a demand for a business, the method seeks to address at least some of the above problems.

### SUMMARY

According to a first aspect of the present invention, there is provided a method for predicting a demand for a business, the method comprising the steps of:

generating purchase preference in at least one target location based on payment transaction information and merchant information retrieved from one or more databases, wherein the payment transaction information relates to a plurality of historical payment transactions made between a plurality of existing merchants and a plurality of consumers and wherein the merchant information comprises a merchant location of each of the plurality of existing merchants; and

predicting the demand in the at least one target location, based on the purchase preference.

The method may further comprise the steps of:

receiving business data from an input module, the business data comprising the at least one target location; and

transmitting the predicted demand for the business to an output module.

The merchant information may further comprise an industrial description of each of the plurality of existing merchants.

Generating the purchase preference in the at least one target location may comprise generating purchase preference within the industry description in the at least one target location.

The at least one target location may comprise at least one selected from a group consisting of a continent, a country, a state, a province, a county, a city and an area covered by a postal code.

The method may further comprise the step of identifying consumer information, the consumer information comprising consumer demographic data of the plurality of consumers.

Generating the purchase preference may comprise generating the purchase preference based on the payment transaction information, the merchant information and the consumer information.

The method may further comprise the steps of:

receiving regional demographic data, the regional demographic data comprising demographic data of a predetermined region surrounding the at least one target location; and

predicting the demand in the at least one target location, based on the purchase preference and the regional demographic data.

Predicting the demand may comprise the steps of:

identifying a plurality of variables, the plurality of variables being dependent on any one of the purchase preference and regional demographic data;

assigning weights to the plurality of variables; and

calculating an opportunity score based on the plurality of variables.

Predicting the demand may comprise predicting a revenue for the business.

According to a second aspect of the present invention, there is provided a server for predicting a demand for a business, the server comprising:

at least one memory storing computer program code, payment transaction information and merchant information, wherein the payment transaction information relates to a plurality of historical payment transactions made between a plurality of existing merchants and a plurality of consumers and wherein the merchant information comprises a merchant location of each of the plurality of existing merchants; and

at least one processor coupled to the at least one memory and configured to, with the computer program code, cause the server at least to:
generate a purchase preference in at least one target location based on the payment transaction information and the merchant information; and
predict the demand in the at least one target location, based on the purchase preference.

According to a third aspect of the present invention, there is provided a computer-readable storage medium having stored thereon computer program code which when executed by a computer causes the computer to execute a method as defined in the first aspect.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a flow chart illustrating a method for predicting a demand for a business according to an example embodiment;

FIG. 2 shows a system for predicting a demand for a business according to an example embodiment; and

FIG. 3 shows an exemplary computing device suitable for executing the method for predicting a demand for a business.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

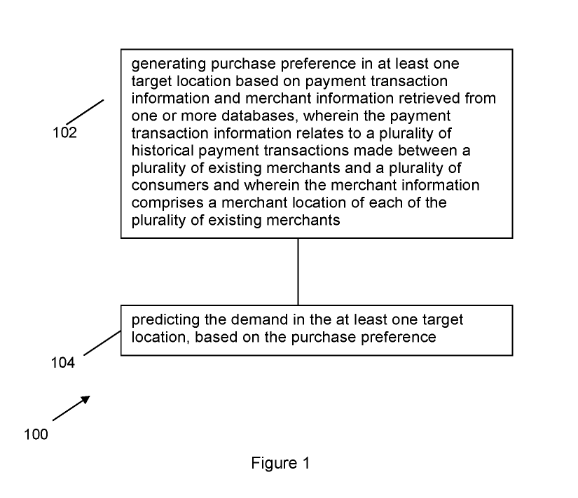

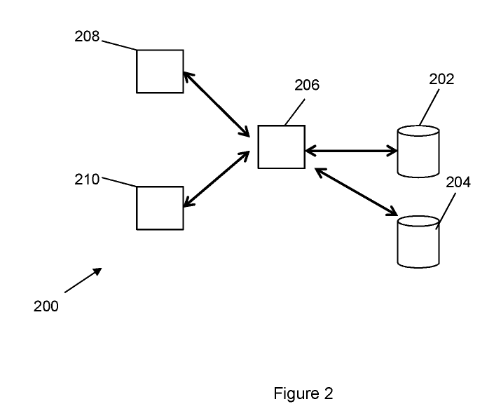

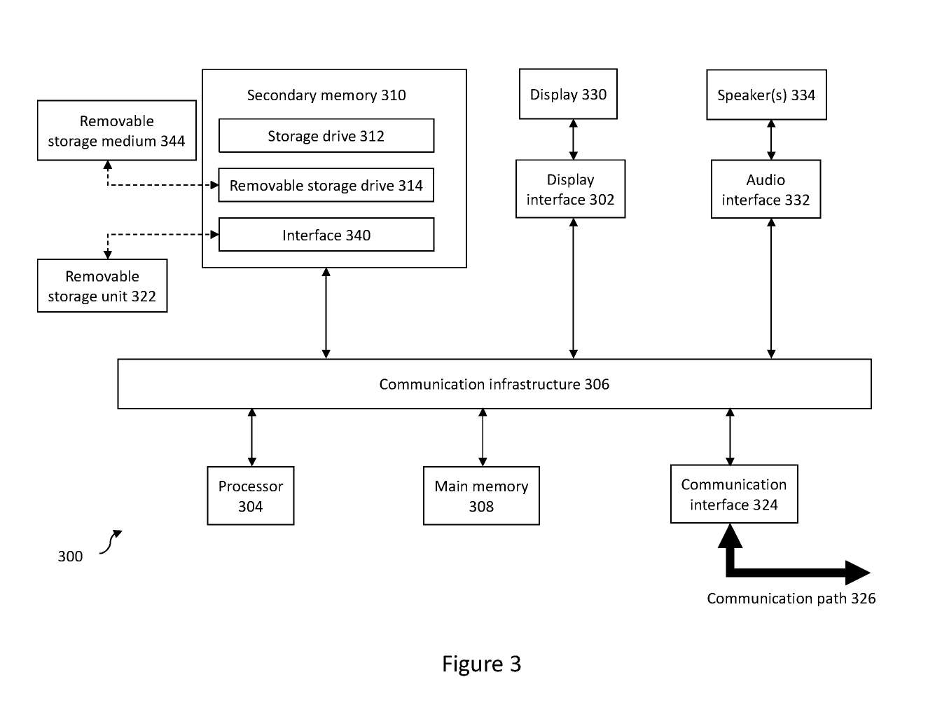

Use of the terms “module” and “database” in FIGS. 1 and 2 may be understood to mean a single computing device or a plurality of interconnected computing devices which operate together to perform a particular function. That is, the “module” and “database” may be contained within a single hardware unit or be distributed among several or many different hardware units. An exemplary computing device which may be operated as a “module” and “database” is described below with reference to FIG. 3.

FIG. 1 shows a flow chart illustrating a method for predicting a demand for a business according to an example embodiment. The method 100 may be performed by one or more purpose-built computing device, such as a prediction module that is coupled to one or more databases. At step 102, a purchase preference in at least one target location is generated based on payment transaction information and merchant information retrieved from one or more databases. The payment transaction information relates to a plurality of historical payment transactions made between a plurality of existing merchants and a plurality of consumers. Further, the merchant information comprises a merchant location of each of the plurality of existing merchants. At step 108, the demand in the at least one target location is predicted based on the purchase preference.

FIG. 2 shows a system 200 for predicting a demand for a business according to an example embodiment. The system 200 comprises at least one internal database (represented as internal database 202), at least one external database (represented as external database 204), a prediction module 206, an input module 208 and an output module 210.

The internal database 202 stores information such as payment transaction data. The payment transaction data relates to a plurality of historical payment transactions made between existing merchants and consumers during a purchase of products or services by the consumers. As shown in FIG. 2, the internal database 202 is communicatively coupled with the prediction module 206.

Currently, many merchants accept electronic payment transactions as an alternative to cash for the payment for products or services. In such electronic payment transactions, a payment card may be used. Typically, in a “card-present” electronic payment transaction, when a payment card holder (consumer) wishes to purchase a product or service from a merchant, the payment card holder presents his/her payment card to the merchant. The merchant typically has a point-of-sale (POS) terminal with a card reader that can interact/communicate with the payment card and facilitates the conduct of the electronic payment transaction. Payment cards are typically uniquely tied to a consumer or card holder account. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing an electronic transaction.

The merchant typically submits a request to an acquirer (a financial institution that processes and settles the merchant's transactions with the help of an issuer). The acquirer then sends the request to the issuer (a financial institution, bank, credit union or company that issues or helps issue cards to payment card holders) to authorize the transaction. A financial institution/payment facilitator (e.g. MasterCard®) acts as an intermediary between the acquirer and the issuer. If the acquirer authorizes the transaction (e.g. there are sufficient funds/credit in the payment card holder's account), the merchant releases the product to the payment card holder.

During a typical electronic payment transaction, certain data associated with the transaction (i.e. electronic payment transaction data) may be generated and the transaction data may be captured/collected by the financial institution/payment facilitator. For example, the transaction data may be uploaded to a data warehouse on a regular basis (e.g. daily, weekly, monthly). If necessary, various algorithms/rules can be applied to anonymize the transaction data so that no personally identifiable numbers are available to the users of the transaction data.

The following types of data can be generated/captured when an electronic transaction is processed:
Transaction information:—
   Transaction ID
   Account ID (anonymized)
   Merchant ID
   Transaction Amount
   Transaction Local Currency Amount
   Date of Transaction
   Time of Transaction
   Type of Transaction
   Date of Processing
   Cardholder Present Code
   Merchant Category Code (MCC)
Account Information:—
   Account ID (anonymized)
   Card Group Code
   Card Product Code
   Card Product Description
   Card Issuer Country
   Card Issuer ID
   Card Issuer Name
   Aggregate Card Issuer ID
   Aggregate Card Issuer Name
Merchant Information:—
   Merchant ID
   Merchant Name
   MCC/Industry Code
   Industry Description
   Factual Merchant Data (store type, type of cuisine served etc.)
   Merchant Country
   Merchant Address
   Merchant Postal Code
   Aggregate Merchant ID
   Aggregate Merchant Name
   Merchant Acquirer Country
   Merchant Acquirer ID
Issuer Information:—
   Issuer ID
   Issuer Name
   Aggregate Issuer ID
   Issuer Country

Various modifications will be apparent to those skilled in the art. For example, instead of one internal database 202 that stores the electronic payment transaction data, the system may comprise two or more internal databases for storing the electronic payment transaction data. Further, in the example embodiment, the historical payment transactions are represented as electronic payment transactions. It will be appreciated by a person skilled in the art that data from non-electronic transactions are also possible to be used to carry out the method.

There may be an external database 204 which is also communicatively coupled to the prediction module 206. The external database 204 stores external data which are typically not available to a particular payment facilitator of the electronic payment transaction. In an example embodiment, the external data may be obtained from aggregator websites, which may be used to generate a purchase preference.

The external data may be provided as supplementary information to the prediction module 206, especially when the information is not available at the internal database 202. The external data may include information such as the merchant information. For example, the type of cuisine served, price range, demographic of patrons, store type, etc.

Various modifications will be apparent to those skilled in the art. For example, instead of one external database 204, the system 200 may comprise two or more external databases. In addition, instead of an external database 204 that provides external data from aggregator websites, the external database 204 may not be required in the system 200 in order to carry out the method for predicting the demand for the business.

As shown in FIG. 2, the internal database 202 and the external database 204 are communicatively coupled with the prediction module 206. The prediction module 206 receives the transaction data from the internal database 202 and the external data from the external database 204. As described above, the transaction data comprises the payment transaction information and merchant information.

The prediction module 206 identifies both the payment transaction information and the merchant information from the transaction data. The merchant information comprises at least the merchant location of each of the existing merchants, such as merchant country, merchant address and merchant postal code. The prediction module 206 analyzes transaction data to generate a purchase preference in at least one target location by associating the payment transaction information with the merchant information. The target location may be a continent, a country, a state, a province, a county, a city and an area covered by a postal code. In an embodiment, the external data is also combined with transaction data in generating the purchase preference. Various algorithms/rules can be stored in the prediction module 206 and can be applied to generate the purchase preference.

An example of purchase preference would be a business profile for all businesses. The business profile comprises predetermined criteria, in which each predetermined criteria may be assessed quantitatively. Examples of the criteria may include popularity, order frequency, density of merchants (nearby merchants), density of similar merchants (nearby competitors), estimated sales per unit area, estimated revenue per store etc. Each criteria can be assessed in various ways, e.g. in a range (for example, 1 to 10), or actual value of the criteria (for example, merchant A generates a monthly revenue of about USD150/m² and merchant B generates a revenue of about USD120/m²). Another example of purchase preference would be quantitative data indicating comparison of the business in comparison with other business (for example, merchant A: 40% market share; merchant B: 60% market share). The purchase preference for similar businesses (for example, Italian restaurant) may be aggregated and averaged for a more accurate result. In another embodiment, purchase preference may simply be traffic pattern at particular period of the day. This may be of concern of certain business owners. For example, business owner of a pubs and bars may wish to know the traffic pattern at night in a target location. Various modifications of a purchase preference will be apparent to those skilled in the art. In general, the purchase preference is indicative of the performance of the businesses in the target location.

In an embodiment where the merchant information comprises industry description of the existing merchants, the purchase preference may be generated within a particular industry/category. For example, the purchase preference in an eatery industry in a postal code may indicate that an Italian restaurant has a higher order frequency or higher popularity than a fast food restaurant. Various modifications of an industrial description will be apparent to those skilled in the art. For example, instead of an eatery, an industry may be a drug store, an electronic store, an apparel store etc. It should also be noted that a merchant may have presence in more than one industry. For example, a hotel may be included in both travel industry and eatery industry. A guideline as to which merchants should be in the grouped in the same industry would be if they are considered as competitor to each other.

In another embodiment, the prediction module 206 receives the transaction data which comprises consumer information such as consumer demographic data in the target location. In other words, the transaction data provides demographic data of the consumers in the target location. Various consumer demographic data may be apparent to a person skilled in the art. For example, age, gender, income information, marital status, number of children in a household etc. The purchase preference may be generated based further on the consumer information.

An input module 208 and output module 210 are illustrated as separate and distinct modules communicatively coupled with the prediction module 206. The input module 208 and output module 210 may be an electronic device such as a mobile phone or a computing device etc. The electronic device may have appropriate communication modules for communicating wirelessly with the prediction module 206 via existing communication protocols.

A user may input business data, via the input module 208, to request for the demand for a business in the target location. The business data comprises at least the location information of the business. The user may also input business data other than the location information, such as the industrial description, the demographic details of target consumers etc.

The demand for the business in the target location may be predicted based on the purchase preference. The prediction module 206 identifies a plurality of variables by selecting the relevant criteria in purchase preference as the variables. For example, the criteria selected to be the variables are popularity score (PS), density of merchants (DM), order frequency (FR), age of the consumers (AC). Weights are assigned to each of the variables based on business logic and regression model, such that an individual score is generated for each of the plurality of variables. An opportunity score is then calculated based on the individual scores. The opportunity score is indicative of the demand for the businesses in the target location.

In yet an embodiment, the prediction module 206 receives a regional demographic data from a database (not shown). The regional demographic data is not related to the transactions data. Rather, the regional demographic data is demographic data of a predetermined region surrounding the target location. Various regional demographic data may be apparent to a person skilled in the art. For example, age, gender, income information, marital status, number of children in a household etc. In an embodiment, predicting the demand in the target location is based on both the purchase preference and the regional demographic data. An example for calculating the opportunity score based on both the purchase preference and the regional demographic data is illustrated in Table 1 below and an example for displaying the opportunity scores in an industry is illustrated in Table 2 below.

Opportunity score (OSL)=f(PS+NM+FR)+f(AC)+f(A+I+PD+G)

TABLE 1
An example for calculating an opportunity score

| Purchase Preference Scores | Regional Demographics Scores |
|---|---|
| Popularity Score (PS) = W_{PS} (PS_{L}) | Age (A) = W_{A} (A_{L}) |
| Density of Merchants (DM) = | Income (I) = W_{I} (I_{L}) |
| W_{DM} (DM_{L}) | |
| Order Frequency (FR) = | Population Density (PD) = |
| W_{Freq} (Freq_{L}) | W_{PD} (PD_{L}) |
| Age of the Consumers (AC) = | Gender (G) = W_{G} (G_{L}) |
| W_{AC} (AC_{L}) | |

*W = weight assigned to the respective variables

TABLE 2
An example for displaying opportunity
score in the eatery industry

| | Opportunity score |
|---|---|
| Type of Eatery | (from 0 to 100) |
| Italian restaurants | 87 |
| Café | 35 |
| Pubs/Bars | 56 |

The predicted demand may then be communicated to the user via the output module 210. In another embodiment, instead of opportunity score, a revenue for the business may be predicted for the business.

Various modifications will be apparent to those skilled in the art. For example, instead of two separate and distinct modules, the input module 208 and output module 210 may be integrated as a single module. In addition, the system 200 may not comprise any one or both of the input module 208 and output module 210. In other words, the system 200 will simply predict the demand in the target location without receiving the request from the user or transmitting the demand to the user. Further, instead of a prediction module configured to carry out the steps of generating the purchase preference and predicting the demand for the business, two separate modules/computing devices maybe used for generating the purchase preference and predicting the demand for the business.

Predicting a demand for a business is important for ensuring that a business success. If the predicted demand for the business is not promising, the business owner can consider other locations, thereby saving time and monetary expenses. Embodiments of the present invention provide method for predicting a demand for a business. The demand is predicted by analyzing actual transactions processed by existing merchants. The method may be advantageous as there is no human bias. In addition, the method also provides accurate results in a fast and simple manner.

FIG. 3 depicts an exemplary computer/computing device 300, hereinafter interchangeably referred to as a computer system 300, where one or more such computing devices 300 may be used to facilitate execution of the above-described method for predicting a demand for a business. In addition, one or more components of the computer system 300 may be used to realize the “module” and “database” in FIGS. 1 and 2. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 340. Examples of a removable storage unit 322 and interface 340 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 340 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the inventions, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for predicting a demand for a business, the method comprising the steps of:
generating purchase preference in at least one target location based on payment transaction information and merchant information retrieved from one or more databases, wherein the payment transaction information relates to a plurality of historical payment transactions made between a plurality of existing merchants and a plurality of consumers and wherein the merchant information comprises a merchant location of each of the plurality of existing merchants; and
predicting the demand in the at least one target location, based on the purchase preference.

2. The method as claimed in claim 1, further comprising the steps of:
receiving business data from an input module, the business data comprising the at least one target location; and
transmitting the predicted demand for the business to an output module.

3. The method as claimed in claim 1, wherein the merchant information further comprises an industrial description of each of the plurality of existing merchants.

4. The method as claimed in claim 3, wherein generating the purchase preference in the at least one target location comprises generating purchase preference within the industry description in the at least one target location.

5. The method as claimed in claim 1, wherein the at least one target location comprises at least one selected from a group consisting of a continent, a country, a state, a province, a county, a city and an area covered by a postal code.

6. The method as claimed in claim 1, further comprising the step of identifying consumer information, the consumer information comprising consumer demographic data of the plurality of consumers.

7. The method as claimed in claim 6, wherein generating the purchase preference comprises generating the purchase preference based on the payment transaction information, the merchant information and the consumer information.

8. The method as claimed in claim 1, further comprising the steps of:
receiving regional demographic data, the regional demographic data comprising demographic data of a predetermined region surrounding the at least one target location; and
predicting the demand in the at least one target location, based on the purchase preference and the regional demographic data.

9. The method as claimed in claim 8, wherein predicting the demand comprises the steps of:
identifying a plurality of variables, the plurality of variables being dependent on any one of the purchase preference and regional demographic data;
assigning weights to the plurality of variables; and
calculating an opportunity score based on the plurality of variables.

10. The method as claimed in claim 1, wherein predicting the demand comprises predicting a revenue for the business.

11. A system for predicting a demand for a business, the system comprising:
at least one memory storing computer program code, payment transaction information and merchant information, wherein the payment transaction information relates to a plurality of historical payment transactions made between a plurality of existing merchants and a plurality of consumers and wherein the merchant information comprises a merchant location of each of the plurality of existing merchants; and
at least one processor coupled to the at least one memory and configured to, with the computer program code, cause the system at least to:
generate a purchase preference in at least one target location based on the payment transaction information and the merchant information; and
predict the demand in the at least one target location, based on the purchase preference.

12. The system as claimed in claim 11, wherein the system is further caused to:
receive business data from an input module, the business data comprising the at least one target location; and
transmit the predicted demand for the business to an output module.

13. The system as claimed in claim 11, wherein the merchant information further comprises an industrial description of each of the plurality of existing merchants.

14. The system as claimed in claim 13, wherein the system is further caused to generate the purchase preference within the industry description in the at least one target location.

15. The system as claimed in claim 11, wherein the at least one target location comprises at least one selected from a group consisting of a continent, a country, a state, a province, a county, a city and an area covered by a postal code.

16. The system as claimed in claim 11, wherein the system is further caused to identify consumer information, the consumer information comprising consumer demographic data of the plurality of consumers.

17. The system as claimed in claim 16, wherein the system is further caused to generate the purchase preference based on the payment transaction information, the merchant information and the consumer information.

18. The system as claimed in claim 11, wherein the system is further caused to:
receive regional demographic data, the regional demographic data comprising demographic data of a predetermined region surrounding the at least one target location; and
generate the predicted demand in the at least one target location, based on the purchase preference and the regional demographic data.

19. The system as claimed in claim 18, wherein the system is further caused to:
identify a plurality of variables, the plurality of variables being dependent on any one of the purchase preference and regional demographic data;
assign weights to the plurality of variables; and
calculate an opportunity score based on the plurality of variables.

20. The system as claimed in claim 11, wherein the system is further caused to predict a revenue for the business.
